(19) United States
(12) Patent Application Publication
(10) Pub. No.: US 2023/0131230 A1
(43) Pub. Date: Apr. 27, 2023

(54) Method and apparatus for blow moulding containers with movable bottom part

(71) Applicant: KRONES AG, Neutraubling (DE)

(72) Inventors: Christian BETZ, Geigant (DE); Benedikt HENGL, Essing (DE); Daniel VOGLER, Neutraubling (DE); Dominik MEIER, Parsberg (DE); Peter KNAPP, Schmatzhausen (DE)

(21) Appl. No.: 17/963,971

(22) Filed: Oct. 11, 2022

(30) Foreign Application Priority Data
Oct. 21, 2021 (DE) 10 2021 127 436.2

(51) Int. Cl. B29C 49/18; B29C 49/12; B29C 49/42; B29C 49/78; B29C 49/28

(52) U.S. Cl. CPC B29C 49/18; B29C 49/12; B29C 49/4289; B29C 49/783; B29C 49/28; B29C 2049/7833; B29L 2031/7158

(57) ABSTRACT

A method for forming plastic preforms into plastic bottles has a first and a second operating mode, wherein the respective operating modes being selectively chosen by an operator as required. In in the first operating mode, i.e. a quality mode, a connection is established between a valve block and a pressure reservoir of the second pressure level in only one direction, from a valve block towards the pressure reservoir, i.e. a compressed air recycling mode, and in a second operating mode, i.e. an efficiency approach, a connection is established between the valve block and the pressure reservoir of the second pressure level in both directions, i.e. from the valve block towards the pressure reservoir and from the pressure reservoir towards the valve block.

### BACKGROUND OF THE INVENTION

The present invention relates to a method and an apparatus for forming plastic preforms into plastic containers and in particular plastic bottles.

Such methods and apparatus have been known in the prior art for a long time. In this process, heated plastic preforms are usually fed into blow moulds and applied with pressure within these blow moulds so that a plastic container or plastic bottle can be formed. The plastic preforms are usually subjected to different pressure levels. For example, it is known that first a pre-blowing pressure is applied, which serves for the initial expansion of the container, then an intermediate blowing pressure and finally a final blowing pressure. Furthermore, it is known from the state of the art that a so-called stretching bar is inserted into the containers to expand them. In addition, prior art processes are also known in which a bottom part of the blow mould is fed to the containers during the expansion process. Such methods are also referred to as active base processes.

In a method of forming plastic preforms into plastic bottles according to the invention, the method comprises the steps:
placing a plastic preform to be expanded in a blow mould, wherein said blow mould having at least two side parts and a bottom part;
inserting a stretching rod through the mouth of the plastic preform into the interior of the plastic preform to stretch it in its longitudinal direction;
applying a first pressure level P1 to the plastic preform;
applying the plastic preform with at least a second pressure level (P+), wherein the second pressure level (P+) differing from the first pressure level P1 and preferably being higher than the first pressure level,
applying the plastic preform with a third pressure level P2, wherein this third pressure level P2 differs from the second pressure level (P+) and is preferably higher than the second pressure level,
in particular
   wherein a pressure reservoir is assigned to each pressure level,
   wherein the method comprising a first and a second mode of operation, wherein the respective modes of operation being selectively chosen by an operator as required, characterised in that
   in the first operating mode, i.e. in a quality mode, a connection is established between a valve block and a pressure reservoir of the second pressure level in only one direction, from a valve block towards the pressure reservoir, i.e. a compressed air recycling, and
   in a second operating mode, i.e. an efficiency approach, a connection is established between the valve block and the pressure reservoir of the second pressure level in both directions, i.e. from the valve block towards the pressure reservoir and from the pressure reservoir towards the valve block.

### SUMMARY OF THE INVENTION

According to at least one embodiment, the method is characterised in that pressure channels of at least two pressure reservoirs can be connected to one another and/or are connected via a connecting valve, so that at least two pressures of pressure channels can be recycled in a controlled and/or regulated manner with respect to one another by means of this one pressure channel assigned to the connecting valve, in particular wherein filling of two compressed air reservoirs takes place via a single valve, for example the connecting valve.

This can mean that the filling of two pressure reservoirs takes place via a single valve.

When filling sensitive products, a forming process is carried out inside a clean room. It is also known to sterilise before the blowing process or even after the blowing process by applying a sterilisation medium, such as hydrogen peroxide.

The compressed air required in particular in the blow moulding machine or its generation is energetically expensive and therefore causes a large proportion of the operating costs in a blow moulding machine and in particular in a stretch blow moulding machine. For example, pressures of up to 40 bar are required to produce PET bottles from plastic preforms. Savings potentials result from various approaches to reuse the generated compressed air at certain pressure levels, i.e. recycling. For example, it is known that different pressure levels are used for the expansion process of the plastic preforms and, for example, the pressure from a higher pressure level can be recycled into a lower pressure level. Thus, such compressed air recycling systems have been developed at the applicant for stretch blow moulding machines, which, depending on the design, reuse parts of the compressed air internally in the machine, but are also partly available for external applications. Such devices are known from the applicant's internal prior art.

Currently, there are three pressure levels in the standard process. P1 as pre-blowing pressure level, Pi as intermediate blowing pressure level and P2 as final blowing pressure level. Each of these pressure levels has its own ring channel and a valve on the valve block of the blowing station in order to be able to direct the pressure into the customer object (preform/bottle).

According to the current status, the valve block of the new Contiform NX generation will have a fifth valve. The object of the fifth valve is to create an additional pressure level between P1 and Pi or P2. Due to this additional pressure level, an increased recycling potential can be used at higher P2 pressures and low P1 pressures.

Decisive for the air consumption is the relief pressure pex at the beginning of the switching of the exhaust valve. If this pressure is very close to the P1 pressure level, it means that the maximum amount of recycled air is used internally for the pressure build-up and the air consumption is minimal.

However, with a very low P2 pressure level and a high P1 pressure level, it can currently happen with only one intermediate blowing level that internally pex comes very close to the P1 pressure and the additional intermediate blowing level of the Contiform NX can no longer offer any added value.

A disadvantage of the state of the art or the second intermediate pressure level is the longer duration until the P2 pressure level is reached and the longer duration when recycling the pressure levels. Due to the fact that each pressure level in the bottle must be formed to a certain extent, and the physical fact that the flow velocity in the bottle slows down considerably shortly before reaching the pressure level, it is evident that both in the pressure build-up there is a prolongation of the pressure build-up to P2, and in the recycling, there is a prolongation of the recycling time, which leads to a reduction of the P2 holding time.

This has a negative impact on bottle quality without, in extreme cases, being able to generate an advantage in air consumption.

Also, according to the current state of the art, the P1 recycling must flow through a pre-blowing throttle. This pre-blowing throttle has the task of limiting the volume flow during pressure build-up. During recycling, however, it would be desirable for the recycling process to be as fast as possible, and the pre-blowing throttle would be a hindrance to this.

The present invention is therefore based on the object of minimising the consumption of energy and/or resources during the forming of plastic preforms into plastic bottles in a cost-effective manner.

This object is solved by a method in which:
a pressure reservoir is assigned to each pressure level,
wherein the method comprising a first and a second mode of operation, wherein the respective modes of operation being selectively chosen by an operator as required, characterised in that
in the first operating mode, i.e. in a quality mode, a connection is established between a valve block and a pressure reservoir of the second pressure level in only one direction, from a valve block towards the pressure reservoir, i.e. a compressed air recycling, and
in a second operating mode, i.e. an efficiency approach, a connection is established between the valve block and the pressure reservoir of the second pressure level in both directions, i.e. from the valve block towards the pressure reservoir and from the pressure reservoir towards the valve block.

According to at least one embodiment, a connection between the pressure reservoir of the first pressure level and a connection between the pressure reservoir of the second pressure level can be established and separated.

According to at least one embodiment, a regulated and/or controlled valve and/or a pairing of a shut-off valve and a regulated and/or controlled throttle valve is arranged between the pressure reservoir of the first pressure level and the pressure reservoir of the second pressure level.

This can mean that five valves (pre-blowing, two intermediate blowing, final blowing and exhaust) are arranged on the valve block.

According to at least one embodiment, at least one of the pressures can be conducted by means of the valve block during the blowing out of compressed air of individual pressure levels in such a way that at least a part of these pressures can be recycled, i.e. restored, among other things.

“Blow out” in the context of the present invention means the introduction of compressed air in a plastic preform to inflate it to the size of a container.

This can mean that during recycling, the compressed air to be recycled can be guided by means of the valve block in such a way that the compressed air to be recycled flows into a pressure reservoir with a lower pressure level. ( . . . and thus refills it)

According to at least one embodiment, at least one valve is provided for generating a pressure level within the pressure reservoir associated with the pressure level, so that the pressure levels are generated by means of a control of the valves.

According to at least one embodiment, the second pressure level is provided by a single pressure reservoir or by at least two separate pressure reservoirs.

A pressure level may be a pressure value of a fluid within a pressure channel, wherein a pressure channel is an at least partially fluid-tight conduit volume for conducting the fluid.

According to at least one embodiment, the second pressure corresponds to an intermediate blowing pressure, and/or the second pressure corresponds to a p+ pressure within a p+ pressure level, or the p+ pressure corresponds to an additional intermediate blowing pressure besides the intermediate blowing pressure already present or to be approached.

According to at least one embodiment, the second pressure level is provided by a single pressure reservoir or by at least two separate pressure reservoirs.

According to at least one embodiment, the additional valve of the p+ pressure channel is arranged at that location of the p+ pressure channel which corresponds to a fluidic connection between the p+ pressure channel and a p1 and/or p2 pressure channel, so that a pressure of the p1 pressure channel and/or a pressure of the p2 pressure channel is at least partially recycled via the p+ pressure channel.

According to at least one embodiment, at least one of the pressure reservoirs, preferably all pressure reservoirs, are in each case formed by means of at least one annular channel.

According to at least one embodiment, the connecting valve is a dome pressure regulator valve or a regulated 2/2-way valve or a shut-off valve with downstream regulated throttle.

Dome pressure regulators are operated by means of gas pressure. In contrast to spring-loaded pressure regulators or pressure reducers, the opening force of the valve required to reduce the pressure is not generated by a spring but by the pressure of a so-called control gas/pilot gas. The gas to be regulated is fed through the pipe into the dome where it meets a valve seat. The control gas is controlled by a built-in control pressure regulator and thus fed into the pressure chamber.

Here it acts on a diaphragm whose stroke movement is transmitted to the valve seat via a diaphragm plate. The valve is thus opened or closed by the pressure of the control gas and the corresponding stroke movement of the diaphragm, depending on the set working pressure, and passes the gas through in the required quantity. Excess control gas is discharged on the downstream pressure side via an integrated gas non-return valve. Dome pressure regulator sets can therefore be closed systems and allow the working pressure to be increased or decreased at any time, even during operation.

2/2-way valves are opening and closing valves which open or close the path of the working medium. These valves can be either closed or open in the basic position. The 2/2-way valve can be operated electrically, pneumatically or electro-pneumatically.

According to at least one embodiment, the p1 pressure channel is fed at least partially, preferably completely, via the p+ pressure channel.

The present invention additionally relates to an apparatus for forming plastic preforms into plastic bottles, wherein the apparatus being particularly adapted and arranged to perform the method according to at least one of the preceding embodiments. This may mean that all features disclosed for the method described herein are also disclosed for the apparatus described herein and vice versa.

According to at least one embodiment, the present invention is an apparatus for forming plastic preforms into plastic bottles, having at least one transport device on which a plurality of forming stations are arranged, wherein each of these forming stations having a blow mould which in each case has two side parts which can be moved with respect to one another in order to open and close the blow mould, and a bottom part, wherein a stretching bar being arranged at each forming station, and wherein the apparatus further having at least one application device, for applying a gaseous medium to the plastic preforms in order to expand them, and a control device which controls the application of the gaseous medium to the plastic preforms in such a way that they are initially applied with a first pressure level, then with at least a second pressure level which is above the first pressure level, and finally with a third pressure level which is preferably above the second pressure level, wherein each pressure level being assigned to a pressure reservoir,

wherein the apparatus is operable in at least a first and a second operating mode, wherein the respective operating modes being selectable by an operator as required, and further wherein,
in the first operating mode, i.e. in a quality mode, a connection between a valve block and a pressure reservoir of the second pressure level can be established in only one direction, from a valve block towards the pressure reservoir, i.e. a compressed air recycling, and
in a second operating mode, i.e. an efficiency approach, a connection can be established between the valve block and the pressure reservoir of the second pressure level in both directions, i.e. from the valve block in the direction of the pressure reservoir and from the pressure reservoir in the direction of the valve block, in particular wherein the second pressure level (P+) is provided by a single pressure reservoir or by at least two separate pressure reservoirs.

### BRIEF DESCRIPTION OF THE DRAWINGS

Further advantages and embodiments can be seen in the attached drawings:

FIG. 1 shows a ring channel P1 according to the present state of the art;

FIG. 1a shows the concept according to the invention in the context of a “Quality” operating method;

FIG. 1b shows the concept according to the invention described here in the context of an “Efficiency” method with the corresponding arrows and the corresponding valves;

FIG. 2 shows a pressure curve diagram according to the invention within the framework of a “quality” process;

FIG. 3 shows a corresponding energy approach;

FIG. 4 shows each ring channel pressure fed with fresh air on demand; and

FIG. 5 shows a second concept where the dome pressure regulator is omitted.

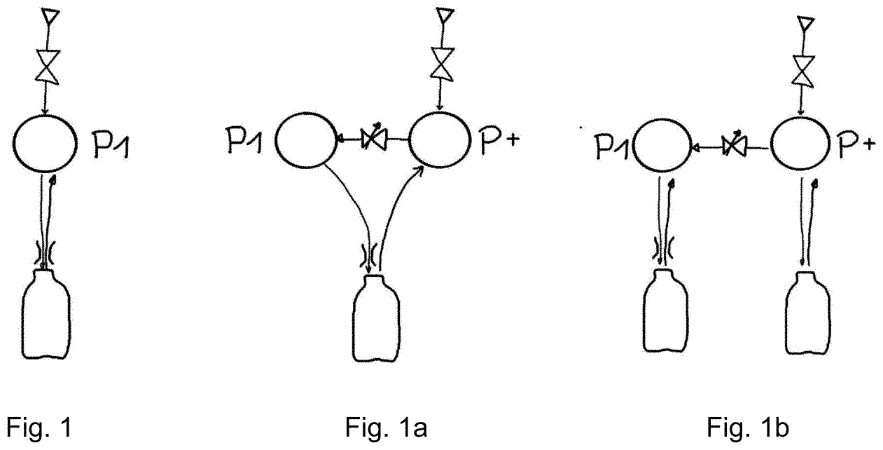

### DETAILED DESCRIPTION OF THE INVENTION

The approach is that the machine operator has the possibility to use the fifth valve and the associated ring channel variably with the same hardware. If it is procedurally necessary to have short rise times and recycling times, the “Quality” approach should be chosen, in which the fifth valve is used as a recycling valve of the P1 pressure level. As a result, when recycling the P1 pressure level, it is not necessary to recycle through the P1 throttle and faster P1 recycling is possible. Also, the additional second intermediate pressure level is completely omitted. Furthermore, the P1 pressure level has an increased volume due to the second ring channel, which has been proven to reduce the pressure fluctuations in the P1 pressure level and to reduce fluctuations in the segment weights. By means of an intermediate valve between p+ (fifth valve) and p1, the supply of P1 air can be controlled/regulated from the P+ air.

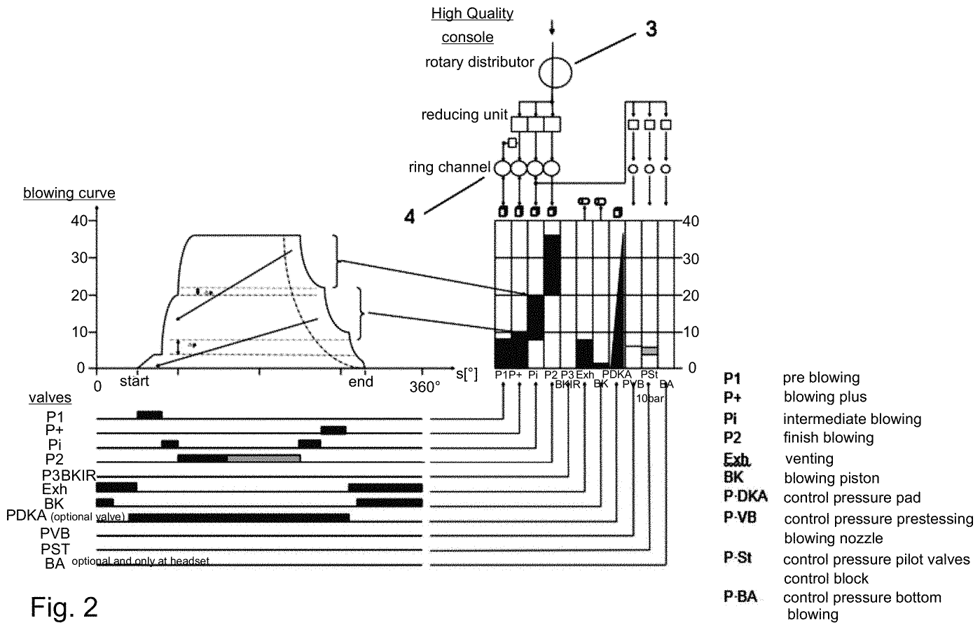

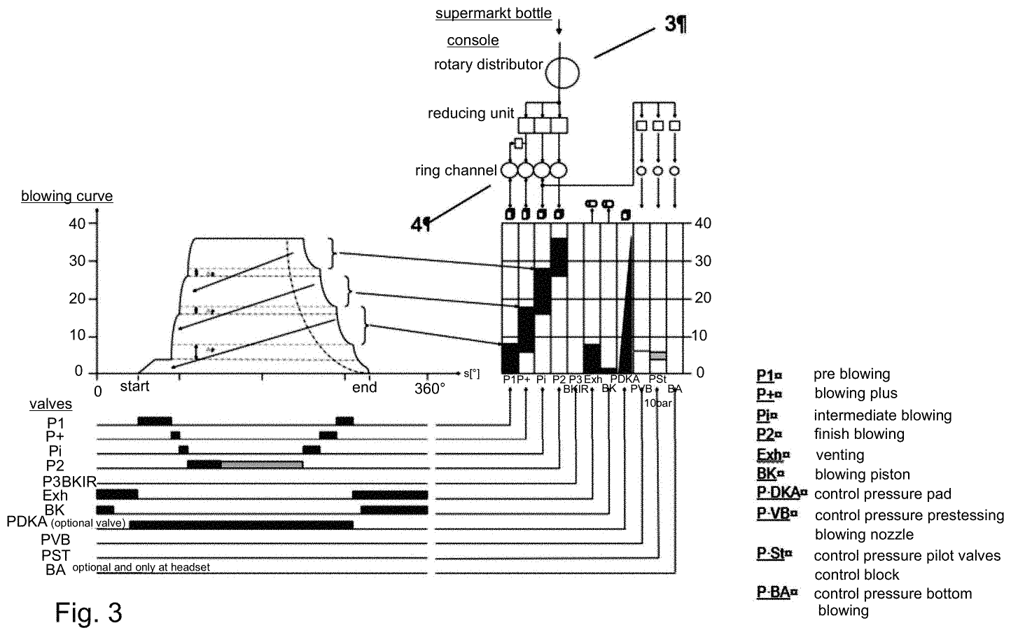

FIG. 2 shows a corresponding pressure curve diagram within the framework of a “quality” process as well as a schematic construction of various ring channels (corresponding to the circles) as well as further corresponding reduction units and a rotary distributor (upper large circle in FIG. 3).

The individual pressure curves, in particular the corresponding response of the individual ring channels is indicated via the transfer diagram from the blowing curve into the corresponding actuation times/actuation pressures relative to time t (see grid pattern).

A corresponding efficiency approach can therefore also be seen in FIG. 3.

With the same hardware, however, the machine operator can also select the “Efficiency” option, where an additional second intermediate blowing pressure level is activated with p+ or the fifth valve. Here, the P1 throttle recycles conventionally and each ring channel is connected conventionally, both in the pressure and recycling phases. With bottles that are not critical in terms of process technology, the maximum amount of air can be recycled in this way, thus keeping air consumption to a minimum. The intermediate valve between p+ and p1 is closed so that no air exchange can take place. If, for unforeseen reasons, p1 has to be supplied with fresh air, the intermediate valve is opened briefly and air can flow from the higher pressure level p+ to p1 until the fresh air requirement is met.

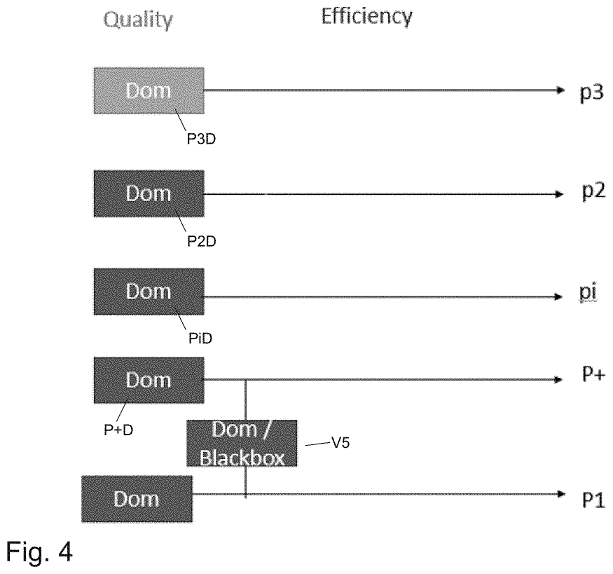

In the concept shown in FIG. 4, each ring channel pressure is fed with fresh air on demand via a dome pressure regulator (P+D, P1 . . . ). At P1 pressure level, a dome pressure regulator would also be necessary for supply. As a connection between P+ and P1, both a directional valve and a conventional dome pressure regulator would be conceivable, which would then not reduce from compressor high pressure to the desired P1 pressure level, but “only” from P+ pressure level.

With the Quality approach with direct connection of the ring channels P+ and P1, the black box valve/dome would be open at least temporarily. In other words, an air/pressure exchange between p+ and P1 would be possible. With the efficiency approach, the black box valve/dome would be closed and each pressure level would be filled “only” via the pure recycling of the blowing air. If a malfunction occurs or the recycling is not sufficient to fill P1 completely, the dome in P1 would have to open briefly and allow a volume flow to P1.

However, due to the high pressure delta between compressor high pressure and P1 pressure, this would result in an increased fluctuation in P1.

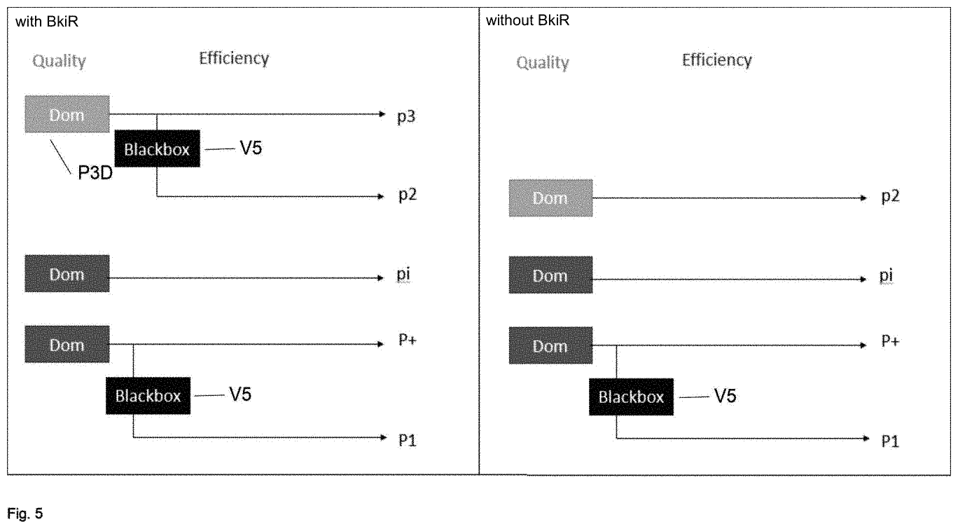

In FIG. 5 a second concept is shown, where the dome pressure regulator in P1 would be omitted and the supply of the P1 pressure level would only be allowed from the P+ pressure level. The concept could still be supplemented with the P2 supply from P3 in order to always have only a number of three dome pressure regulators. This is analogous to the efficiency approach of the P1 ring channel and is not described further below, but would be technically possible and would make sense.

With this concept, the black box valve would be open at least temporarily, preferably permanently, in the Quality approach with direct connection of the ring channels P+ and P1. In other words, an air/pressure exchange between p+ and P1 would be possible. With the efficiency approach, the black box valve would be closed and each pressure level would be filled “only” via the pure recycling of the blowing air. If a malfunction occurs or if the recycling is not sufficient to fill P1 completely, the black box valve would have to open briefly and allow air to flow from p+ to P1. Although this would increase the fluctuation of the p+ ring channel, it would not be as critical from a process engineering point of view as in the p1 ring channel.

Currently, there are three pressure levels in the standard process, especially without blowreycling. P1 as pre-blowing pressure level, Pi as intermediate blowing pressure level and P2 as final blowing pressure level. Each of these pressure levels has, in at least one embodiment, its own ring channel and a valve on a valve block of the blowing station to direct the pressure into a plastic preform and/or bottle.

According to an embodiment according to the invention, the valve block also presented here is to have a connecting valve, also as a fifth valve.

The object of the connecting valve in at least one embodiment is to create an additional pressure level between the pressures P1 and Pi or P2. Due to this additional pressure level, an increased recycling potential can be used at higher P2 pressures and low P1 pressures.

Decisive for the air consumption is the exhaust pressure pex at the beginning of the switching of the exhaust valve. If this pressure is very close to the P1 pressure level, it means that the maximum amount of recycled air is used internally for the pressure build-up and the air consumption is minimal.

Incidentally, the connection also overcomes a disadvantage of the prior art, namely that up to now the second intermediate pressure level, which is prolonged, and thus a duration until the P2 pressure level is reached and the prolonged duration when recycling the pressure levels, slows down the blowing process. Due to the fact that each pressure level in the bottle has to form to a certain extent and the physical fact that the flow velocity slows down considerably shortly before reaching the pressure level in the bottle, it becomes apparent that both in the pressure build-up there is a prolongation of the pressure build-up to P2 and in the recycling there is a prolongation of the recycling duration, which leads to a reduction of the P2 holding time.

This has a negative impact on bottle quality without, in extreme cases, being able to generate an advantage in air consumption.

Also, according to the current state of the art, the P1 recycling must flow through a pre-blowing throttle. This pre-blowing throttle has the object of limiting the volume flow during pressure build-up. During recycling, however, it would be desirable for the recycling process to be as fast as possible, and the pre-blowing throttle would be a hindrance to this.

In brief, the state of the art has the following disadvantages:
When the fifth valve is added as an intermediate blowing level, the P2 holding phase is shortened.
Recycling of P1 air through preblow throttle leads to extended recycling times

A key point of the invention is now to adjust the fifth valve variably during the blowing process.

One approach is therefore to use the fifth valve as a recycling valve of P1, i.e. the P1 pressure level, so that in at least one possible embodiment there is a connection between a ring channel of the fifth valve and a P1 ring channel and in this case the fifth valve applies an intermediate pressure and the connection to P1, i.e. the P1 pressure level is disconnected.

The approach taken is that the machine operator has the option of being able to use the fifth valve and the associated ring channel variably with unchanged hardware.

Indeed, if it is procedurally necessary to have short rise times and recycling times, the “Quality” approach should be chosen, where the fifth valve is used as a recycling valve of the P1 pressure level.

As a result, when recycling the P1 pressure level, it is not necessary to recycle through the P1 throttle and faster P1 recycling is possible. Also, an additional second intermediate pressure level is completely eliminated.

Furthermore, the P1 pressure level has an increased volume due to the second ring channel (i.e. the p+ ring channel), which has been proven to reduce the pressure fluctuations in the P1 pressure level and to reduce fluctuations in segment weights.

By means of an intermediate valve between p+(fifth valve) and p1, the supply of P1 air can be controlled/regulated from the P+ pressure level.

With the same hardware, however, the machine operator can also select the “Efficiency” option, in which an additional second intermediate blowing pressure level is activated with p+ or the fifth valve. In this case, the P1 throttle recycles conventionally and each ring channel is connected conventionally, both in the pressure and the recycling phase.

In the case of bottles that are not critical in terms of process technology, the maximum amount of air can be recycled in this way, thus keeping air consumption to a minimum. The intermediate valve between the p+ pressure stage and the p1 pressure level is closed so that no air exchange can take place. If, for unforeseen reasons, the p1 pressure channel needs to be supplied with fresh air, the intermediate valve is opened briefly and air can flow from the higher p+ pressure level to p1 until the fresh air requirement is met.

Several implementation concepts exist to implement the above procedure:

Two promising approaches are described below. The aim is that the ring channels P1 and P+ can be in direct connection and at the same time this connection can be disconnected. This would also be conceivable with other pressure levels, but only with these ring channels is this described in the following as an example.

This connection of the ring channels can be made, for example, by a 2/2-way valve that is stable at 40 bar. A dome pressure regulator would also be conceivable as a shut-off device.

### Embodiment 1

In the concept shown here, each ring channel pressure is fed with fresh air as needed via a dome pressure regulator. At P1 pressure level, a dome pressure regulator would also be necessary for supply. As a connection between the P+ pressure channel and the P1 pressure channel, both a directional valve and a dome pressure regulator would be conceivable, which would then not reduce from compressor high pressure to the desired P1 pressure level, but “only” from P+ pressure level.

With the “Quality” approach, with direct connection of the ring channels P+ and P1, the valve would be open at least temporarily. In other words, an air/pressure exchange between p+ and P1 would be possible.

In the “efficiency” approach, the valve would be closed and each pressure level would be filled “only” via the pure recycling of the blowing air. If a malfunction occurs or the recycling is not sufficient to fill P1 completely, the dome in P1 would have to open briefly and allow a volume flow to P1. However, due to the high pressure delta between compressor high pressure and P1 pressure, this would result in an increased fluctuation in P1.

### Embodiment 2

The second embodiment would omit the dome pressure regulator in the P1 pressure channel and only allow the P1 pressure level to be fed from the P+ pressure level. The concept could still be supplemented with P2 feeding from P3 to always have only a number of three dome pressure regulators. This is analogous to the “efficiency” approach of the P1 ring channel and is not described further below, but would be technically possible and would make sense.

In at least one further embodiment, it would be conceivable that in the “Quality” approach with direct connection of the ring channels P+ and P1, the valve is open at least temporarily, preferably permanently. In other words, an air/pressure exchange between p+ and P1 would be possible. With the “efficiency” approach, the valve would then be closed and each pressure level would be filled “only” via the pure recycling of the blowing air. If a malfunction occurs or if the recycling is not sufficient to fill P1 completely, the valve would have to open briefly and allow air to flow from p+ to P1. Although this would increase the fluctuation of the p+ ring channel, it would not be as critical from a process engineering point of view as in the p1 ring channel.

Thereby, in brief, the above invention may have the following advantages:
Maximum flexibility through individual use of the fifth valve,
elimination of the P1 dome pressure regulator and better stability of the P1 pressure level in the “Quality” approach:
higher P1 stability due to “buffer channel” and omission of the recycling level in P1
lower P1 pressure levels due to better stability
only one intermediate blowing level
faster “P1” recycling due to cease of the throttle when recycling P1 air
no change in hardware compared to “Efficiency” version
for bottles with increased requirements and higher P1 pressure, it makes sense to use the fifth valve
with each approach, air consumption is optimised, operating costs are minimal and there is no need for a major rebuild of the system.

The applicant reserves the right to claim all features disclosed in the application documents as essential to the invention, provided they are individually or in combination new compared to the prior art. Furthermore, it is pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

### LIST OF REFERENCE SIGNS

1 apparatus
2 transport device
3 rotary distributor
5 reducing units
4 ring channel
10 plastic bottle (also plastic preform)
10a container bottom
14 blow-mould side part
16 support shell
18 bottom part
15 cavity
20 moulding stations
32 blowing nozzle
34 rod-like body, stretching bar
36 drive device for moving the bottom part 18
52 curve of the pressure profile
54 curve of the stretching bar movement
56 curve of the movement of the bottom part
P1 first pressure, pre-blowing pressure
Pi second pressure, intermediate blowing pressure
P2 third pressure, final blowing pressure
Sp rinsing pressure
E exhaust(pressure)
P0, P10 positions of the stretching bar
Z rotary axis
P transport path
WP1,WP2 turning points of the pressure profile curve
L longitudinal direction
V5 connection valve
P+D dome pressure regulator
PiD dome pressure regulator
P1D dome pressure regulator
P2D dome pressure regulator
P3D dome pressure regulator

1. A method of forming plastic preforms into plastic bottles comprising the steps:
placing a plastic preform to be expanded in a blow mould, wherein said blow mould comprising at least two side parts and a bottom part;
inserting a stretching rod through the mouth of the plastic preform into the interior of the plastic preform to stretch it in its longitudinal direction (L);
applying a first pressure level (P1) to the plastic preform;
applying the plastic preform with at least a second pressure level (P+, Pi), wherein the second pressure level (P+, Pi) differs from the first pressure level (P1) and is preferably higher than the first pressure level (P1),
applying the plastic preform with a third pressure level (P2), wherein this third pressure level (P2) differing from the second pressure level (P+) and preferably being higher than the second pressure level (P+),
wherein a pressure reservoir is assigned to each pressure level,
wherein the method comprises a first and a second mode of operation, wherein the respective modes of operation being selectively chosen by an operator as required,
wherein
in the first operating mode, i.e. in a quality operation, a connection is established between a valve block and a pressure reservoir of the second pressure level (P+, Pi) in only one direction, from a valve block towards the pressure reservoir, i.e. a compressed air recycling, and
in a second operating mode, i.e. an efficiency approach, a connection is established between the valve block and the pressure reservoir of the second pressure level (P+, Pi) in both directions, i.e. from the valve block towards the pressure reservoir and from the pressure reservoir towards the valve block.

2. The method according to claim 1,
wherein
a connection between the pressure reservoir of the first pressure level and a connection between the pressure reservoir of the second pressure level can be established and separated.

3. The method according to claim 1,
wherein
a regulated and/or controlled valve and/or a pairing of a shut-off valve and a regulated and/or controlled throttle valve is arranged between the pressure reservoir of the first pressure level and the pressure reservoir of the second pressure level.

4. The method according to claim 1,
wherein
during a blow-out, compressed air of individual pressure levels of at least one of the pressures (P2, Pi, P1) can be conducted by the valve block in such a way that at least a part of these pressures can be recycled, i.e. inter alia recovered.

5. The method according to claim 1,
wherein
pressure channels, at least two pressure reservoirs can be connected to one another and/or are connected via a connecting valve, so that at least two pressures of pressure channels can be controlled and/or recycled in a regulated manner with respect to one another by a pressure channel assigned to the connecting valve, in particular wherein two pressure reservoirs are filled via a single valve, for example the connecting valve.

6. The method according to claim 1,
wherein
at least one valve is provided for generating a pressure level within a pressure reservoir associated with the pressure level, so that the pressure levels are generated by means of a control of the valves.

7. The method according to claim 1,
wherein
the second pressure level (P+) is provided by a single pressure reservoir or by at least two separate pressure reservoirs.

8. The method according to claim 5,
wherein
the connecting valve is a dome pressure regulator valve or a regulated 2/2-way valve or a shut-off valve with downstream regulated throttle.

9. The method according to claim 1,
wherein
the P1 pressure channel is fed at least partially, preferably completely, via the P+ pressure channel.

10. An apparatus for forming plastic preforms into plastic bottles, having at least one transport device on which a plurality of forming stations are arranged, wherein each of these forming stations having a blow mould which in each case has two side parts, which can be moved with respect to one another in order to open and close the blow mould, and a bottom part, wherein a stretching bar being arranged at each forming station, and wherein the apparatus furthermore having at least one application device configured for applying the plastic preforms with a gaseous medium in order to expand them, and a control device configured to control the application of the plastic preforms with the gaseous medium in such a way that they are first applied with a first pressure level (P1), then with at least one second pressure level (Pi), which is above the first pressure level (P1), and finally with a third pressure level (P2), which is preferably above the second pressure level (Pi), wherein
a pressure reservoir is assigned to each pressure level,
wherein the apparatus is operable in at least a first and a second operating mode,
wherein the respective operating modes being selectable by an operator as required, and further wherein,
in the first operating mode, i.e. in a quality mode, a connection can be established between a valve block and a pressure reservoir of the second pressure level in only one direction, from a valve block in the direction of the pressure reservoir, i.e. a pressure recycling, and in a second operating mode, i.e. an efficiency approach, a connection can be established between the valve block and the pressure reservoir of the second pressure level in both directions, i. E. form the valve block in the direction of the pressure reservoir and from the pressure reservoir in the direction of the valve block, in particular wherein the second pressure level (P+) is provided by a single pressure reservoir or by at least two separate pressure reservoirs.
